(19) United States
(12) Patent Application Publication
(10) Pub. No.: US 2003/0124037 A1
(43) Pub. Date: Jul. 3, 2003

(54) Catalyst and method for reducing exhaust gas emissions

(75) Inventors: Kenneth E. Voss, Somerville, NJ (US); Stanley Roth, Yardley, PA (US); Joseph C. Dettling, Howell, NJ (US); Gary W. Rice, Scotch Plains, NJ (US); Yiu Kwan Lui, Parlin, NJ (US); Mahmoud Yassine, Edison, NJ (US)

Correspondence Address: Chief Patent Counsel, Engelhard Corporation, 101 Wood Avenue, P.O. Box 770, Iselin, NJ, 08830-0770, US

(73) Assignee: ENGELHARD CORPORATION, Iselin, NJ

(21) Appl. No.: 10/327,453

(22) Filed: Dec. 20, 2002

Related U.S. Application Data
(63) Continuation of application No. 09/191,603, filed on Nov. 13, 1998, now abandoned.

(51) Int. Cl. B01D 53/94; B01D 53/34

(52) U.S. Cl. 422/177; 422/171; 422/180

(57) ABSTRACT

An apparatus useful to treat exhaust gas stream, including diesel engine exhaust. The exhaust stream passes form and exhaust outlet to a catalyzed filter in communication with the exhaust outlet. The catalyzed filter comprises a first catalyst which comprises a first platinum group metal; a first cerium component; and preferably a zirconium component. There can be a second catalyst in communication with the first catalyst, the second catalyst comprises a second cerium component.

### BACKGROUND OF THE INVENTION

1. Field of the Invention

This invention relates to an apparatus comprising a catalytic element in communication with a catalyzed filter element, and method for the oxidation of oxidizable components of a gas-borne stream, e.g., for treatment of diesel engine exhaust, and more specifically to the treatment of such diesel exhaust to reduce the particulates content thereof. Where the catalyzed element and catalyzed filter are located in an exhaust stream of a diesel engine with the catalyzed element located between the engine and the catalyzed filter element.

2. Background and Related Art

As is well-known, gas-borne streams from industrial processes or engine exhausts often contain oxidizable pollutants such as unburned fuel and vaporized or condensed oils. For example, diesel engine exhaust contains not only gaseous pollutants such as carbon monoxide (“Co”) and unburned hydrocarbons (“HC”), but also soot particles which, as described in more detail below, comprise both a dry carbonaceous fraction and a hydrocarbon liquid which is sometimes referred to as a volatile organic fraction (“VOF”), which terminology will be used herein, or a soluble organic fraction. Accordingly, although sometimes loosely referred to as an “exhaust gas”, the exhaust of a diesel engine is actually a heterogeneous material, comprising gaseous, liquid and solid components. The VOF may exist in diesel exhaust either as a vapor or as an aerosol. (fine droplets of liquid condensate) depending on the temperature of the diesel exhaust.

Oxidation catalysts comprising a platinum group metal dispersed on a refractory metal oxide support are known for use in treating the exhaust of diesel engines in order to convert both HC and CO gaseous pollutants and particulates, i.e., soot particles, by catalyzing the oxidation of these pollutants to carbon dioxide and water. One problem faced in the treatment of diesel engine exhaust is presented by the presence of sulfur in diesel fuel. Upon combustion, sulfur forms sulfur dioxide and the oxidation catalyst catalyzes the SO₂ to SO₃ (“sulfates”) with subsequent formation of condensable sulfur compounds, such as sulfuric acid, which condense upon, and thereby add to, the mass of particulates. The sulfates also react with activated alumina supports to form aluminum sulfates, which render activated alumina-containing catalysts inactive. In this regard, see U.S. Pat. No. 4,171,289 at column 1, line 39 et seq. Previous attempts to deal with the sulfation problem include the incorporation of large amounts of sulfate-resistant materials such as vanadium oxide into the support coating, or the use of alternative support materials such as alpha-alumina (a-alumina), silica and titania, which are sulfation-resistant materials.

U.S. Pat. No. 5,462,907 is directed to a ceria-alumina oxidation catalyst. This patent discloses oxidation catalyst compositions including a catalytic material containing ceria and alumina each having a surface area of at least about 10 m²/g, for example, ceria and activated alumina in a weight ratio of from about 1.5:1 to 1:1.5. Optionally, platinum may be included in the catalytic material in amounts which are sufficient to promote gas phase oxidation of CO and HC but which are limited to preclude excessive oxidation of SO₂ to SO₃. Alternatively, palladium in any desired amount may be included in the catalytic material. The catalyst compositions are disclosed to have utility as oxidation catalysts for pollution abatement of exhaust gases containing unburned fuel or oil. For example, the catalyst compositions may be used in a method to treat diesel engine exhaust by contacting the hot exhaust with the catalyst composition to promote the oxidation of the volatile organic fraction component of particulates in the exhaust. Related U.S. Pat. No. 5,491,120 is directed to an oxidation catalyst with bulk ceria and a second bulk metal oxide. This patent discloses that the second bulk metal oxide may be one or more of titania, zirconia, ceria-zirconia, silica, alumina-silica and a-alumina. There are disclosures, such as U.S. Pat. Nos. 4,714,694 and 5,057,483 disclosing a variety of catalyst compositions which include ceria in bulk form, alumina stabilized ceria and ceria-zirconia components.

Catalyzed soot filters are known from references such U.S. Pat. Nos. 4,510,265 and 5,100,632. These references disclose the use of catalyzed soot filters in diesel exhaust streams. Reference is also made to SAE Technical Paper Series No. 860298, update on the evaluation of diesel particulate filters for underground mining by A. Lawson, et al.

U.S. Pat. No. 4,902,487 discloses a process for treatment of diesel exhaust gases wherein diesel exhaust gas is passed through a filter to remove particulate therefrom before discharge and particulate deposited on the filter is combusted. In this process, gas containing NO₂ is disclosed to be catalytically generated in the exhaust stream. This is disclosed to be accomplished by putting a catalyst upstream of the filter. The upstream catalyst is disclosed to produce NO₂ in a diesel exhaust stream which contains NO.

A common method of pollution abatement of gas streams involves the use of a catalytic article in the form of multi-channel flow through structures. Such structures include multi-channel honeycomb structures where the honeycomb can be made of metal, ceramic or a catalyst containing composition. The honeycomb, for example, can be made by extrusion, calendaring or corrugation. The catalyst can be on the surface of the honeycomb or part of the honeycomb composition. For example, U.S. Pat. No. 4,157,375 discloses zeolite catalyzed reduction of nitrogen oxides in exhaust gases conducted with catalytic articles in the form of multi-channel structures in which parallel channels are defined by thin walls made up of refractory oxides having zeolite dispersed therein and accessible to diffusion from surfaces of the channel walls. The reaction rate for this type of multi-channel parallel flow through catalyst configuration for catalytic reactions is often rate limited by bulk mass transfer and pore diffusion constraints.

Another method of pollution abatement relates to the filtering of particulate material from diesel engine exhaust gases using a catalyzed filter. Many references disclose the use of wallflow filters which comprise catalysts on or in the filter to filter and burn off filtered particulate matter. A common construction is a multi-channel honeycomb structure having the ends of alternate channels on the upstream and downstream sides of the honeycomb structure plugged. This results in checkerboard type pattern on either end. Channels plugged on the upstream or inlet end are opened on the downstream or outlet end. This permits the gas to enter the open upstream channels, flow through the porous walls and exit through the channels having open downstream ends. The gas to be treated passes into the catalytic structure through the open upstream end of a channel and is prevented from exiting by the plugged downstream end of the same channel. The gas pressure forces the gas through the porous structural walls into channels closed at the upstream end and opened at the downstream end. Such structures are primarily disclosed to filter particles out of the exhaust gas stream. Often the structures have catalysts on or in the substrate which enhance the oxidation of the particles. Typical patents disclosing such catalytic structures include U.S. Pat. Nos. 3,904,551; 4,329,162; 4,340,403; 4,364,760; 4,403,008; 4,519,820; 4,559,193 and 4,563,414.

Of interest is U.S. Pat. No. 3,904,551 which discloses a system in which the substrate has a catalyst coating. It is disclosed in U.S. Pat. No. 4,329,162 that a catalytic substance can be placed on the walls of the honeycomb structure to facilitate regeneration combustion in the body of that structure. U.S. Pat. No. 4,559,193 recognizes that a ceramic honeycomb body can carry catalysts. U.S. Pat. No. 4,340,403 discloses that where honeycombs are used for filters, there should be a separate honeycomb substrate carrying catalysts downstream for removal of carbon monoxide, hydrocarbons and nitrogen oxides. The honeycomb filter used upstream is viewed as only filtering particulate matter to prevent clogging of the catalytic honeycomb used to remove the gaseous pollutants. Similarly U.S. Pat. No. 4,364,760 discloses the use of an upstream ceramic honeycomb filter which can burn the fine particles into carbon monoxide and hydrocarbons which can be treated by a separate three-way catalyst means. Other patents disclosing honeycomb type filters useful as diesel particulate traps include U.S. Pat. Nos. 4,441,856; 4,427,728; 4,455,180; 4,557,962; 4,576,774; 4,752,516 and 4,759,892.

U.S. Pat. No. 4,510,265 describes a self-cleaning diesel exhaust particulate filter which contains a catalyst mixture of a platinum group metal and silver vanadate, the presence of which is disclosed to lower the temperature at which ignition and incineration of the particulate matter is initiated. Filters are disclosed to include thin porous walled honeycombs (monoliths) or formed structures through which the exhaust gases pass with a minimum pressure drop. Useful filters are disclosed to be made from ceramics, generally crystalline, glass ceramics, glasses, metals, cements, resins or organic polymers, papers, textile fabrics and combinations thereof.

U.S. Pat. No. 5,100,632 also describes a catalyzed diesel exhaust particulate filter and a method of removing deposits from the exhaust gas of a diesel engine. The method involves passing the exhaust gases through a catalyzed filter having porous walls where the walls have thereon as a catalyst a mixture of a platinum group metal and an alkaline earth metal. The catalyst mixture is described as serving to lower the temperature at which ignition of collected particulate matter is initiated. The filter element was found to result in particle burn-off from the catalyzed filter. Additionally, gaseous emissions from the diesel exhaust were recorded with the catalyzed filter versus no filter. The results showed that the catalyzed filters compared to using no filter resulted in 113 parts per million carbon monoxide versus 5 parts per million carbon monoxide for a catalyzed filter. Total hydrocarbons with no filter were 84 parts per million and with a filter were 41 parts per million. Nitric oxide went from 417 parts per million with no filter to 326 parts with a catalyzed filter. Total NO, went from 460 parts per million with no filter to 403 parts per million with a catalyzed filter; and nitrous oxide went from 43 parts with no filter to 77 parts with a catalyzed filter. It was observed that the presence of the catalyzed particulate filter in the exhaust system of a diesel engine has a generally positive effect on reducing the gaseous emissions of the system.

Japanese Kokai 3-130522 discloses the treatment of diesel exhaust gases characterized by use of an ammonia injector and porous ceramic filter having a denitration catalyst within the pores. The filter is installed in the wake of the diesel engine exhaust. The ceramic porous filter comprises an upstream fine pore path layer, and a downstream side course ceramic particle layer on which the denitration catalyst was supported. The fine layer can support a platinum or palladium or other hydrocarbon combustion catalyst. The diesel exhaust gas containing unburned carbon flows through the porous ceramic filter and the carbon particles are filtered onto the surface. The gas containing nitric oxides and the ammonia passes through the denitration catalyst containing side of the filter and the nitric oxides are reduced to nitrogen and water. The oxidation catalyst on the upstream side causes the particulate component to burn off catalytically.

U.S. Pat. No. 4,404,007 is directed to a ceramic honeycomb structure wherein there are a plurality of projections provided over the entire wall surfaces of the cells in the structure body.

U.S. Pat. No. 5,114,581 is directed to a back-flushable filtration device. The device includes a monolith of porous material having an inlet and an outlet end. The passage ways of the monolith are alternately plugged at the inlet and the outlet ends of the monolith, thereby preventing a direct passage of feed stock through the passageways from the inlet to the outlet end. A microporous membrane of mean porous size smaller than the mean pore size of the monolith material covers the surface of the passage ways. U.S. Pat. No. 5,221,484, which is a continuation-in-part of U.S. Pat. No. 5,114,581 is directed to a catalytic filtration device for separating particulate feed stock into a filtrate and particulate containing filter cake. The catalytic filtration device is suitable for catalyzing a gas phase reaction. Reactions which may be catalyzed include the reduction of oxides of nitrogen, the oxidation of sulfur dioxide, and the oxidation of volatile organic vapors.

### SUMMARY OF THE INVENTION

The present invention relates to an apparatus and related method for oxidizing oxidizable components of a gas-borne stream, for example, for treating diesel engine exhaust.

The present invention provides an apparatus comprising a catalyzed filter. The catalyzed filter comprises a first catalyst, the first catalyst comprising a first platinum group metal and a first cerium component. There is a second catalyst in communication with the first catalyst. The second catalyst comprises a second cerium component. The catalyzed filter can be any suitable filter substrate. For treating diesel engine exhaust, the filter is commonly referred to as a soot filter, with a preferred soot filter comprising a wall flow honeycomb substrate. The second catalyst is preferably supported on a flow through honeycomb substrate.

The apparatus is particularly effective with regard to reducing the total particulates in the exhaust gas streams, particularly diesel engine exhaust gas streams. The carbonaceous particulates (“soot”) component of diesel engine exhaust is, as is well-known, comprised of two major components. One component is relatively dry carbonaceous particles and the other, usually referred to as a volatile organic fraction (“VOF”) also referred to as a soluble organic fraction (“SOF”), is a mixture of high molecular weight hydrocarbons comprised of unburned and partially burned diesel fuel and lubricating oil. The volatile organic fraction is present in the diesel exhaust as either a vapor phase or a liquid phase, or both, depending on the temperature of the exhaust. In order to reduce the total particulates discharged so as to meet present and impending Government regulations concerning maximum allowable total particulates, the volatile organic fraction, or at least a portion thereof, is oxidized to innocuous CO₂ and H₂O by being contacted with an oxidation catalyst under suitable reaction conditions. The particulate matter can additionally be filtered on a soot filter. The soot filter can be catalyzed to enable it to burn off trapped particles as the exhaust temperature increases to above the “light-off” temperature of the catalyst. That is the temperature at which catalytic combustion occurs. The Balance Point Temperature (BPT) is the temperature at which the soot burning rate achieved by the catalytic soot filter is equal to the soot accumulation rate in the filter. A lower BPT is preferred. The specific apparatus of the present invention enable lower BPT's to be achieved while efficiently using platinum group catalyst components.

A preferred apparatus for treating diesel engine exhaust comprises, in combination, a diesel engine having an exhaust outlet, a catalyzed filter in communication with the exhaust outlet, and a second catalyst in communication with the first catalyst. The catalyzed filter comprises a first catalyst which comprises a first platinum group metal and a first cerium component. The second catalyst comprises a second cerium component.

An alternative and preferred apparatus comprises a diesel engine having an exhaust outlet. A catalyzed filter communicates with the exhaust outlet. The catalyzed filter comprises a first catalyst comprising a first platinum group metal, a first cerium component, and a first zirconium component. A more preferred embodiment of this alternative apparatus a second catalyst in communication with the first catalyst, where the second catalyst comprises a second cerium component.

The configuration of the apparatus can be varied. Preferably, the second catalyst is located between the engine outlet and the first catalyst. Alternatively, the second catalyst can be located between the engine outlet and the catalyzed filter. In this embodiment the second catalyst can be supported on a separate substrate than the catalyzed filter such as flow through honeycomb substrate. Alternatively, the second catalyst can be located at the catalyzed filter. In this embodiment, the catalyzed filter has an axial length extending from an upstream filter end to a downstream filter end, and the second catalyst is located for at least part of the axial length from the upstream end. The second catalyst can extend for from about 0.25 to about 8 inches and preferably, from about 0.5 to about 5 inches from the upstream end.

In yet another embodiment, the second catalyst can be located downstream of the first catalyst. Alternatively, the second catalyst is located downstream of the first catalyst. In this embodiment the second catalyst can be supported on a separate substrate than the catalyzed filter such as flow through honeycomb substrate. Alternatively, the second catalyst can be located at the catalyzed filter. In this embodiment, the catalyzed filter has an axial length extending from an upstream filter end to a downstream filter end, and the second catalyst is located for at least part of the axial length from the downstream end. The second catalyst can extend for from about 0.25 to about 8 inches and preferably, from about 0.5 to about 5 inches from the downstream end.

A preferred first catalyst composition of the first catalyst useful for the catalyzed soot filter comprises a first platinum group metal component, a first cerium component and preferably a first zirconium component.

Where a second catalyst is used in combination with the first catalyst, as a separate catalytic element or as part of the soot filter, a preferred second catalyst composition comprises a second cerium component and preferably a second platinum group metal component. Preferably, the second catalyst composition comprises a second metal oxide selected from silica, alumina, titania, zirconia, silica-alumina and ceria-zirconia.

In a useful second catalyst composition the second cerium component is bulk ceria having a BET surface area of at least about 10 m²/g and the second metal oxide is a bulk metal oxide having a BET surface area of at least about 10 m²/g. The second catalyst composition comprises ceria and a metal oxide in a weight ratio of from 5:95 to 95:5.

The second catalyst can comprise at least one second platinum group metal component. Useful second platinum group component can be selected from platinum, palladium, and rhodium components. The second platinum group components are preferably present in an amount of from 0.1 to 200 g/ft³ based on the weight of the metal.

Where the second platinum group component is a platinum component in an amount from 0.1 to 15 g/ft³, preferably from 0.1 to 5 g/ft³, based on the weight of the metal. In a useful second platinum group component the second platinum component can be present in an amount from 0.1 to 0.5 g/ft³ based on the weight of the metal.

The first catalyst composition can comprises a first metal oxide selected from silica, alumina, titania, zirconia, silica-alumina and ceria-zirconia.

In a useful first catalyst composition the first cerium component is bulk ceria having a BET surface area of at least about 10 m²/g and the first metal oxide is a bulk metal oxide having a BET surface area of at least about 10 m²/g. The first catalyst composition comprises ceria and a metal oxide in a weight ratio of from 5:95 to 95:5.

The first catalyst can comprise at least one first platinum group metal component. Useful first platinum group component can be selected from platinum, palladium, and rhodium components. The first platinum group components are preferably present in an amount of from 0.1 to 200 g/ft³ based on the weight of the metal.

### Definitions

As used herein and in the claims, the following terms shall have the indicated meanings.

The term “gas-borne stream” means a gaseous stream which may contain non-gaseous components such as solid particulates and/or vapors, liquid mist or droplets, and/or solid particulates wetted by a liquid.

The term “BET surface area” has its usual meaning of referring to the Brunauer, Emmett, Teller method for determining surface area by N₂ absorption. Unless otherwise specifically stated, all references herein to the surface area of bulk ceria, the second metal oxides, or other components means the BET surface area.

The term “activated alumina” has its usual meaning of a high BET surface area alumina, comprising primarily one or more of gamma-, theta- and delta-aluminas (y-, 0- and 6-aluminas).

The term “catalytically effective amount” means that the amount of material present is sufficient to affect the rate of reaction of the oxidation of pollutants in the exhaust being treated.

The term “inlet temperature” shall mean the temperature of the exhaust, test gas or other stream being treated immediately prior to initial contact of the exhaust, test gas or other stream with the catalyst composition.

The term “ceria metal oxide catalytic material” means a combination of ceria and metal oxides selected from the class consisting of one or more of titania, zirconia, ceria-zirconia, silica, alumina-silica and alumina, the ceria having a BET surface area of at least about 10 m²/g, and the average surface area of the combination of high surface area ceria and metal oxide being at least 10 m²/g.

The term “combination” when used with reference to a combination of (a) bulk ceria and (b) bulk second metal oxide or (c) the foregoing and bulk activated alumina, includes combinations attained by mixtures or blends of (a) and (b) and/or (c) and superimposed discrete layers of (a) 5 and (b) and/or (c)

“Zirconium-stabilized ceria” or “aluminum-stabilized ceria” means ceria which has been stabilized against thermal degradation by incorporation therein of a zirconium or an aluminum compound. As is well-known, high surface area refractory oxides such as ceria and activated alumina are subject to loss of surface area (thermal degradation) and consequent reduction in catalytic efficiency upon prolonged exposure to high temperatures a suitable ceria-stabilization technique is shown in U.S. Pat. No. 4,714,694 of C. Z. Wan, et al., issued on Dec. 22, 1991, the disclosure of which is incorporated herein. As disclosed in U.S. Pat. No. 4,714,694, ceria particles are impregnated with e.g., an aqueous solution of a soluble aluminum compound such as aluminum nitrate, aluminum chloride, aluminum oxychloride, aluminum acetate, etc. After drying and calcining the impregnated ceria in air at a temperature of, e.g., from about 300° C. to 600° C. for a period of ½ to 2 hours., the aluminum compound impregnated into the ceria particles is converted into an effective thermal stabilizer for the ceria.

As indicated above, the Balance Point Temperature (“BPT”) is the temperature at which the soot burning rate achieved by the catalytic soot filter is equal to the soot accumulation rate in the filter.

### BRIEF DESCRIPTION OF THE DRAWINGS

FIG. 1 is a schematic drawing of a preferred embodiment of the present invention.

FIG. 2 is a schematic view in perspective of a wallflow catalytic honeycomb.

FIG. 3 is a partial, sectional view of the element showing the alternate plugged channels.

FIG. 4 is a sectional view of a portion of a wallflow honeycomb wall.

FIG. 5 is a schematic view in perspective of a alternative wallflow catalytic honeycomb

FIG. 6 is a schematic drawing of a alternative-embodiment of the present invention.

### DETAILED DESCRIPTION OF THE INVENTION AND PREFERRED EMBODIMENTS THEREOF

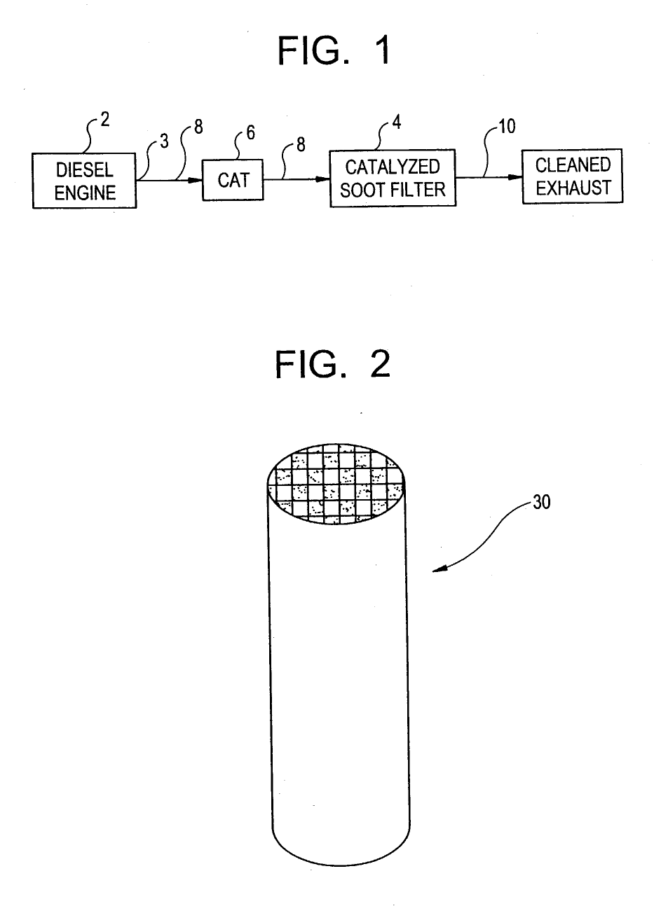

The apparatus and related method of the present invention for oxidizing oxidizable components of a gas-borne stream such as in diesel engine exhaust, will be understood by those skilled in the art by reference to the accompanying FIGS. 1 through 5 and the description provided in this specification.

The application of the foregoing method is of particular interest for fluid streams which are gaseous in nature. Typically, such gaseous streams are waste gas streams such as internal combustion exhaust, nitric acid plant tail gases, power plant exhaust gases and other industrial exhaust gases which cause pollution and, therefore, their discharge into the atmosphere is undesirable. Such gaseous streams are comprised of undesirable components including those selected from the group consisting of ozone, nitrogen oxides, ammonia, carbonaceous materials and mixtures thereof.

The apparatus is particularly effective with regard to reducing the total particulates in the exhaust gas streams, particularly diesel engine exhaust gas streams. The carbonaceous particulates (“soot”) component of diesel engine exhaust is, as is well-known, comprised of three major components. One component is relatively dry solid carbonaceous particles and the second, usually referred to as a volatile organic fraction (“VOF”) also referred to as a soluble organic fraction (“SOF”), is a mixture of high molecular weight liquid phase hydrocarbons comprised of unburned and partially burned diesel fuel and lubricating oil. The third major component is the so-called “sulfate” which comes from oxidation product of sulfur in the fuel SO₃ which in turn combines with water in the exhaust to form condensable H₂SO₄. The volatile organic fraction is present in the diesel exhaust as either a vapor phase or a liquid phase, or both, depending on the temperature of the exhaust. In order to reduce the total particulates discharged so as to meet present and impending Government regulations concerning maximum allowable total particulates, the volatile organic fraction, or at least a portion thereof, is oxidized to innocuous CO₂ and H₂O by being contacted with an oxidation catalyst under suitable reaction conditions. The catalyzed filter can burn off trapped particles as the exhaust temperature increases to above the “light-off” temperature of the catalyst. That is the temperature at which catalytic combustion occurs. The Balance Point Temperature (BPT) is the temperature at which the soot burning rate achieved by the catalytic soot filter is equal to the soot accumulation rate in the filter. A lower BPT is preferred. The specific apparatus of the present invention enable lower BPT's to be achieved while efficiently using platinum group catalyst components.

A preferred embodiment of the present invention provides an apparatus comprising a catalyzed filter. The catalyzed filter comprises a first catalyst, the first catalyst comprising a first platinum group metal and a first cerium component. There is a second catalyst in communication with the first catalyst. The second catalyst comprises a second cerium component. The catalyzed filter can be any-suitable filter substrate. For treating diesel engine exhaust, the filter is commonly referred to as a soot filter, with a preferred soot filter comprising a wall flow honeycomb substrate. The second catalyst is preferably supported on a flow through honeycomb substrate.

A preferred embodiment is schematically illustrated by reference to FIG. 1. Exhaust gas passes from a diesel engine 2. The apparatus comprises a catalyzed filter 4. The catalyzed filter 4 comprises a first catalyst, the first catalyst comprising a first platinum group metal and a first cerium component. There is a second catalyzed element comprising a second catalyst 6 in communication with the first catalyst. The second catalyst comprises a second cerium component. In the embodiment illustrated in FIG. 1 exhaust gas passes from the diesel engine 2 through exhaust gas conduit 8, through catalytic element 6, to catalyzed soot filter 4. Optionally, there can be a section of exhaust gas conduit 8 between the catalytic element 6 and the catalyzed soot filter 8. Alternatively, catalyzed filter 4 and catalytic element 6 can he adjacent to each other in adjacent housings (referred to as cans) or adjacent to each other within the same housing. The gas than passes from the catalyzed system to exhaust pipe 10 and then into the environment.

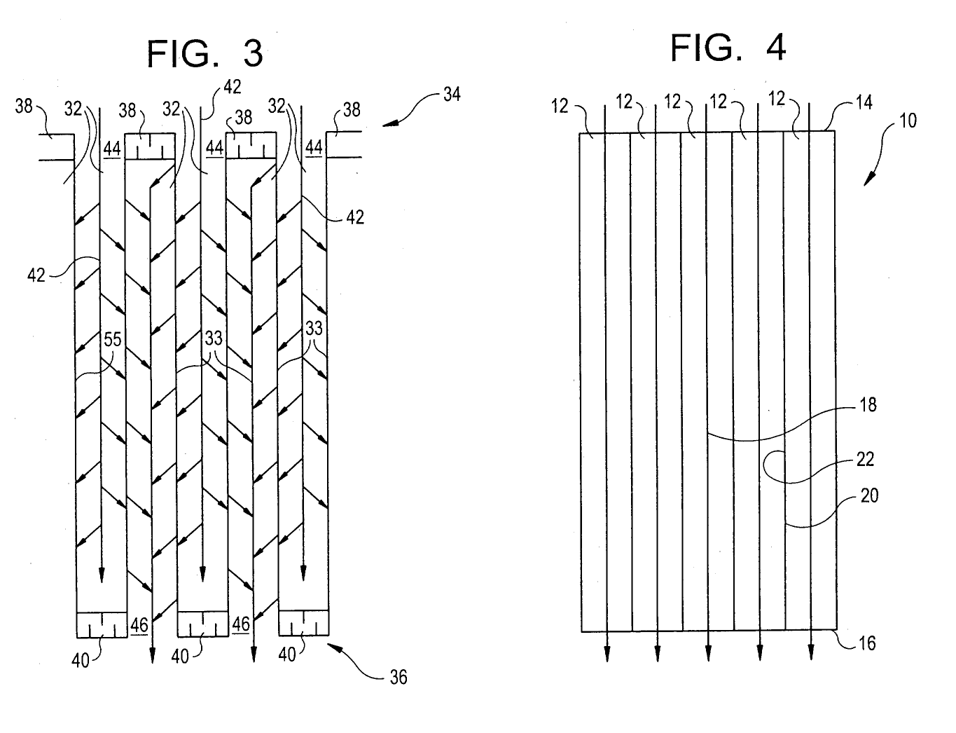

The catalyzed filter can comprise any suitable filter substrate. For treating diesel engine exhaust, the filter is commonly referred to as a soot filter, with a preferred soot filter comprising a wallflow honeycomb substrate, FIGS. 2 and 3. The second catalyst is preferably supported on a flow-through honeycomb substrate, FIG. 4.

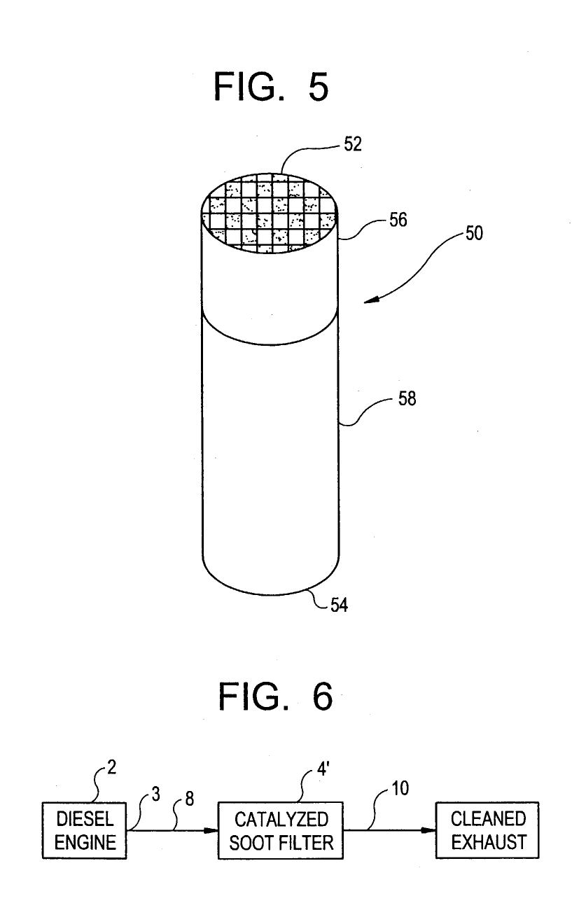

The Configuration of the apparatus can be varied. Preferably, as recited, the second catalytic element 6 comprising the second catalyst is located between the diesel engine 2 exhaust outlet 3 and the first catalyst of the catalyzed filter 4. In this embodiment the second catalyst can be supported on a separate substrate than the catalyzed filter such as flowthrough honeycomb substrate, FIG. 4. Alternatively, as shown on FIG. 5, the second catalyst can be located at the catalyzed filter 50. In this embodiment, the catalyzed filter 50 has an axial length extending from an upstream filter end 52 to a downstream filter end 54. The second catalyst is located for at least part of the axial length 56 from the upstream end 58. The second catalyst can extend for from about 0.25 to about 8 inches and preferably, from about 0.5 to about 5 inches from the upstream end. The first catalyst can extend for at least part of the length from downstream end 54 toward upstream end 52. There can be a gap between lengths 56 and 58.

In yet another embodiment, the second catalyst can be located downstream of the first catalyst. Reference is made to FIGS. 1 and 5. In corresponding embodiments elements 4 and 6 of FIG. 1 are reversed and elements 56 and 58 of FIG. 5 are reversed along exhaust conduit 8. In this embodiment the second catalyst can be supported on a separate substrate than the catalyzed filter such as flow through honeycomb substrate. Alternatively, the second catalyst can be located at the catalyzed filter. In this embodiment, the catalyzed filter has an axial length extending from an upstream filter end to a downstream filter end, and the second catalyst is located for at least part of the axial length from the downstream end. The second catalyst can extend for from about 0.25 to about 8 inches and preferably, from about 0.5 to about 5 inches from the downstream end.

In yet another alternative and preferred embodiment illustrated in FIG. 6, which has reference characters corresponding to those of FIG. 1 for corresponding elements, first catalyst composition of the first catalyst useful for the catalyzed soot filter 4′ comprises a first platinum group metal component, a first cerium component and preferably a first zirconium component. Exhaust gas passes from a diesel engine 2. The apparatus comprises a catalyzed filter 4′. The catalyzed filter 4′ comprises a first catalyst, the first catalyst comprising a first platinum group metal and a first cerium component. Optionally, and preferably, this embodiment can be used the catalyzed soot filter 4 illustrated in FIG. 1. In the embodiment illustrated in FIG. 6 exhaust gas passes from the diesel engine 2 through exhaust gas conduit 8, through catalytic element 6, to catalyzed soot filter 4′. The gas than passes from the catalyzed system to exhaust pipe 10 and then into the environment.

In a useful first catalyst composition the first cerium component is preferably and typically deposited on the soot filter as a soluble salt such as cerium nitrate. Also useful for slurry coating soot filter is bulk ceria having a BET surface area of at least about 10 m²/g and the first metal oxide is a bulk metal oxide having a BET surface area of at least about 10 m²/g. The first catalyst composition comprises ceria and a metal oxide in a weight ratio of from 5:95 to 95:5. Useful cerium components are disclosed in U.S. Pat. Nos. 4,714,694 and 5,057,483 both herein incorporated by reference. These include bulk ceria, zirconium stabilized ceria, aluminum stabilized ceria, and ceria compounds including rare earth metal oxides such as lanthanum, praseodymium and neodymium compound. The latter may be composites co-formed with the cerium component.

The first catalyst can comprise at least one first platinum group metal component. Useful first platinum group component can be selected from platinum, palladium, and rhodium components. The first platinum group components are preferably present in an amount of from about 0.1 to 200 g/ft³, preferably from about 5 to 150 g/ft³, more preferably from about 10 to 100 g/ft³ based on the weight of the metal. Where the platinum group metal is platinum the preferred amount of platinum component based on platinum metal is from about 10 to 100 g/ft³ and more preferably from about 15 to 75 g/ft³ for the catalyzed soot filter. Where the platinum group metal is palladium the preferred amount of palladium component based on palladium metal is from about 25 to 200 g/ft³ and more preferably from about 25 to 150 g/ft³ for the catalyzed soot filter. Mixtures of platinum group metal components can be used.

The first catalyst composition can comprises a first metal oxide selected from silica, alumina, titania, zirconia, silica-alumina and ceria-zirconia.

In the embodiment illustrated in FIG. 6 the first catalyst comprises a first platinum group metal component, a first cerium component and preferably a first zirconium component. In this embodiment the relative amounts of the components are present in a weight ratio from 1-60% zirconia based on the weight of ceria plus zirconi, preferably 5-50% and more preferably 10-40%. The total loading of catalyst components on the soot filter substrate is typically present in the amount from about 20 g/ft³ to 2500 g/ft³ and preferably from about 50 g/ft³ to 1500 g/ft³ and more preferably 100 g/ft³ to 1500 g/ft³.

Generally, within the first catalyst useful as a catalyzed soot filter the catalyst can contain additional other components known for use in catalyzed soot filters such alkaline earth metal oxides as disclosed in U.S. Pat. No. 5,100,632 herein incorporated by reference.

Where a second catalyst is used in combination with the first catalyst, as a separate catalytic element or as part of the soot filter, a preferred second catalyst composition comprises a second cerium component and optionally a second platinum group metal component. Preferably, the second catalyst composition comprises a second metal oxide selected from silica, alumina, titania, zirconia, silica-alumina, zeolite and ceria-zirconia. In a useful second catalyst composition the second cerium component is bulk ceria having a BET surface area of at least about 10 m²/g and the second metal oxide is a bulk metal oxide having a BET surface area of at least about 10 m²/g. The second catalyst composition comprises ceria and a metal oxide in a weight ratio of from 5:95 to 95:5.

The second catalyst can comprise at least one second platinum group metal component. Useful second platinum group component can be selected from platinum, palladium, and rhodium components. The second platinum group components are preferably present in an amount of from 0.1 to 200 g/ft³ based on the weight of the metal.

Where the second platinum group component is a platinum component in an amount from 0.1 to 15 g/ft³, preferably from 0.1 to 3 g/ft³, more preferably from 0.1 to 5 ³g/ft³, yet more preferably from 0.1 to 10 g/ft³ based on the weight of the metal. In a useful second platinum group component the second platinum component can be present in an amount from 0.1 to 0.5 g/ft³ based on the weight of the metal.

Useful second catalyst are disclosed in U.S. Pat. Nos. 4,714,694 and 5,057,483 both herein incorporated by reference. Preferably, the second catalyst is designed for reducing diesel exhaust particulates emissions by oxidation of the volatile organic fraction thereof. This can be attained by a catalytic material which comprises a cerium component. Preferably, the cerium component is combined as a mixture with one or more selected second metal oxides. The basic and novel characteristics of the second catalyst of the present invention are believed to reside in the use of the defined combination of ceria and preferably the second metal oxide as an oxidation catalyst without the addition of platinum group metal components thereto. However, a indicated above and in the cited patent platinum group metal components can be included as part of the second catalyst.

Preferably, but not necessarily, ceria-as well as the second metal oxides, are in bulk form, and preferably have a surface area of at least about 10 m²/g, preferably at least about 20 m²/g. For example, the bulk ceria may have a surface area of from about 70 to 150 m²/g. The combination of ceria and the second metal oxides should have a BET surface area of 10 m²/g or higher optionally, up to about 90 percent by weight, e.g., from about 5 to 90 percent by weight, of the total weight of bulk ceria, second metal oxide and activated alumina may be provided by the activated alumina, which may have a BET surface area of 10 m²/g or higher, preferably at least about 20 m²/g, e.g., a surface area of from about 120 to 180 m²/g. When alumina is present, each of the ceria, alumina and other metal oxide is preferably present in the amount of at least about 5 percent by weight of the total weight of metal oxides present.

A catalyst composition in accordance with the present invention effectively catalyzes the oxidation of the volatile organic fraction so as to provide a significant reduction in total particulates in diesel engine exhaust and exhibits good durability, that is, long life. It should be noted that the prior art generally considers refractory base metal oxides used in diesel oxidation catalysts to be merely supports for the dispersal thereon of catalytically active metals such as platinum group metals. In contrast, the present invention teaches that a ceria-second metal oxide catalytic material consisting essentially of only bulk ceria and one or more selected bulk second metal oxides which provides a mixture of sufficiently high surface area, e.g., at least 10 m²/g, preferably at least 20 m²/g, and dispersed on a suitable carriers provides a durable and effective diesel oxidation catalyst.

It has further been found that beneficial effects are attained in some circumstances by the optional incorporation of platinum or palladium in the second catalyst composition. The platinum can be present at loadings much lower than those conventionally used in oxidation catalysts.

If a catalytic metal such as platinum is added to the catalytic composition, it serves to catalyze the oxidation of gas phase HC and CO pollutants as an added benefit. However, such catalytic metal is not needed to supplement the action of the ceria-second metal oxide catalytic material in reducing total particulate emissions. The catalytic metal, be it platinum or palladium, does not appear to play a role in controlling particulates in that the quantity or type of metal (platinum or palladium) utilized in the catalytic material does not significantly affect the rate of particulates conversion.

The second catalytic element catalysts of the present invention may take the form of a carrier or substrate, such as a monolithic honeycomb structure (a body having a plurality of gas flow passages extending therethrough), onto which is applied a coating of the catalytic material comprising a mixture of high surface area ceria and one or more second metal oxides and, optionally, activated alumina and, optionally, platinum or palladium. The preferred substrate is a flowthrough honeycomb substrate. As discussed below, discrete coatings of the ceria, second metal oxide and alumina may be employed.

Following is a general method of preparation of the catalyst composition which can be applied to embodiments of the first and second catalysts. The ceria containing catalytic materials of the present invention may be prepared in the form of an aqueous slurry of ceria particles and other components such as metal oxide particles, the particles optionally being impregnated with the platinum or palladium catalytic metal component, if one is to be utilized. The slurry is then applied to the carrier, dried and calcined to form a catalytic material coating (“washcoat”) thereon. Typically, the ceria and second metal oxide particles are mixed with water and an acidifier such as acetic acid, nitric acid or sulfuric acid, and ball milled to a desired particle size.

The optional catalytic metal component, e.g., platinum or palladium, is, when used, preferably dispersed on the ceria particles or on the metal oxide particles, or on both the ceria and second metal oxide particles. If activated alumina is present as part of the combination of the catalytic material, some or all of the catalytic metal component may be dispersed on it. In such cases, the ceria and/or second metal oxides and/or activated alumina act as both as a catalytic material and a support for the optional catalytic metal component. Such incorporation may be carried out after the ceria-second metal oxide catalytic material is coated as a washcoat onto a suitable carrier, by impregnating the coated carrier with a solution of a compound of the metal, followed by drying and calcination. However, preferably, the ceria particles or both the ceria and metal oxide particles are impregnated with a compound of the platinum or palladium catalytic metal before a coating of the ceria second metal oxide catalytic material is applied to the carrier. In either case, the optional platinum or palladium metal may be added to the ceria-metal oxide catalytic material as a solution of a soluble compound of the metal, the solution serving to impregnate the ceria and metal oxide particles, which may then be dried and the platinum or palladium fixed thereon. Fixing may be carried out by calcination or by treatment with hydrogen sulfide or by other known means, to render the metal in water-insoluble form.

Generally, the slurry of ceria and metal oxide particles, and activated alumina if present, whether or not impregnated with the platinum or palladium metal salt solution, will be deposited upon the carrier substrate and dried and calcined to adhere the catalytic material to the carrier and, when the catalytic metal compound is present, to revert the platinum or palladium compound to the elemental metal or its oxide. Suitable platinum or palladium compounds for use in the foregoing process include potassium platinum chloride, ammonium platinum thiocyanate, amine-solubilized platinum hydroxide, chloroplatinic acid, palladium nitrate, and palladium chloride, as is well known in the art. During calcination, or at least during the initial phase of use of the catalyst, such compounds, if present, are converted into the catalyticly active elemental metal or its oxide.

In an alternate catalyst composition design, separate, discrete layers of bulk ceria, bulk metal oxide and, optionally, bulk activated alumina may be employed. These discrete layers are applied as separate coats superimposed one above the other on the carrier. The order of application of such discrete layers is not important and each layer (of ceria, second metal oxide and, optionally, activated alumina) may comprise either the first-applied or inner coat or layer, the last-applied or outer coat or layer or, if a third layer is present, the intermediate layer or coat. More than three layers may be used, e.g., a layer of a given material may be repeated or two or more of the second metal oxides may be present as discrete layers of different second metal oxides. When a catalytic metal is present in a catalyst composition in which the catalytic material is present in two or more discrete layers or coats of materials, the catalytic metal may be dispersed in any one or more of the discrete layers or coats.

When the catalytic material is applied as a thin coating or coatings to a suitable carrier, such as described above, the proportions of ingredients are conventionally expressed as weight of material per unit volume of catalyst, as this measure accommodates the presence of different sizes of catalyst composition voids provided by different carrier wall thicknesses, gas flow passage dimensions, etc. Grams per cubic inch (“g/in³”) units are used to express the quantity of relatively plentiful components such as the ceria-metal oxide catalytic material, and grams per cubic foot (“g/ft³”) units are used to express the quantity of the sparsely used ingredients, such as the platinum or palladium metal. For typical diesel exhaust applications, the ceria-second metal oxide catalytic, material of the present invention generally may comprise from about 0.25 to about 4.0 g/in³, preferably from about 0.25 to about 3.0 g/in³ of the coated carrier substrate, optionally including from about 0 to 25, preferably from about 0 to 15 g/ft³ of platinum or 0 to 200 g/ft³ preferably from about 0 to 120 g/ft³ of palladium.

Generally, other ingredients may be added to the catalyst composition of the present invention such as conventional thermal stabilizers for the activated alumina when it is present, e.g., rare earth metal oxides such as ceria. Thermal stabilization of high surface area ceria and alumina to militate against phase conversion to less catalytically effective low surface area forms is well-known in the art although, as noted above, thermal stabilization of alumina is not usually needed for diesel exhaust service. Such thermal stabilizers may be incorporated into the ceria (or activated alumina when it is used) by impregnating the particles with, e.g., a solution of a soluble compound of the stabilizer metal, for example, an aluminum nitrate solution in the case of stabilizing the ceria, and then drying and calcining the impregnated ceria to convert the aluminum nitrate impregnated therein into alumina. In one embodiment, the catalyst composition of the present invention consists essentially only of the high surface area ceria and high surface area second metal oxide, preferably present in a weight proportion of 1.5:1 to 1:1.5, with or without thermal stabilizers impregnated therein, and, optionally, platinum in a limited amount or palladium. The basic and novel characteristic of this invention in believed to reside in the use of the combined ceria and second metal oxide as a catalyst without necessity of the inclusion of precious metal or other catalytic metals except the optional inclusion of platinum or palladium.

The Carrier (Substrate)

The carrier used in this invention should be relatively inert with respect to the catalytic composition dispersed thereon. The preferred carriers are comprised of ceramic-like materials such as cordierite, a-alumina, silicon nitride, zirconia, mullite, spodumene, alumina-silica-magnesia or zirconium silicate, or of refractory metals such as stainless steel. The carriers are preferably of the type sometimes referred to as honeycomb or monolithic carriers, comprising a unitary cylindrical body having a plurality of fine, substantially parallel gas flow passages extending therethrough and connecting both end-faces of the carrier to provide a “flow-through” type of carrier. (See FIG. 4) Such monolithic carriers may contain up to about 700 or more flow channels (“cells”) per square inch of cross section, although far fewer may be used. For example, the carrier may have from about 7 to 600, more usually from about 200 to 400, cells per square inch (“cpsi”). Flow-through carriers are preferred as substrates for the second catalyst.

FIG. 4 illustrates a flow-through honeycomb 10 which has a plurality of channels 12. The honeycomb has an inlet end 14 and an outlet end 16. Each channel 12 is open at the inlet side 14 and open at the outlet side 16. Gases passing through the honeycomb indicated by arrows 18 enter through inlet end 14 and exit from outlet end 16. The gases pass through the channels 12. The channels have channel walls 20. The channel walls 20 are coated with a layer of catalyst composition 22 applied as recited above. The catalyst composition is on each side of the channel walls 20 so that each honeycomb channel is coated with catalyst. The gases passing through the honeycomb contact the channel by diffusing into the catalyst surface in a direction perpendicular to the direction of flow.

Wallflow carriers, which are illustrated in FIGS. 2 and 3 are generally similar in structure to flow-through carriers, with the distinction that each channel is blocked at one end of the carrier body, with alternate channels blocked at opposite end-faces. Wallflow carrier substrates and the support coatings deposited thereon are necessarily porous, as the exhaust must pass through the walls of the carrier in order to exit the carrier structure. Wallflow carriers are preferred as substrates for the catalytic filter which acts as a substrate for the first catalyst.

As indicated above wallflow article means and includes conventional filter type articles of the type made from cordierite, mullite, alumina and/or other refractory metal oxides conventionally used for this purpose. The element may be formed of any porous material which is able to withstand the environment(s), particularly high temperatures, encountered in treating the fluid streams of interest. In the practice of the present invention, the catalyzed filter is placed in a housing which directs the fluid stream to be treated through the inlet to the inlet side of the element. The fluid passes through the porous wall comprising a catalyst to the outlet side and out of the outlet. Wallflow catalytic filters useful for the purposes of this invention include thin, porous-walled honeycomb (monolith) or foam structures through which the fluid stream passes without causing too great an increase of back pressure or pressure drop across the article. Normally, the presence of a clean wallflow article will create a back pressure of 1 inch water column to 10 cpsi. Wallflow articles can contain slotted channels separated by parallel walls, sinusoidal channels composed of alternating flat and sinusoidal sheets, or parallel channels having rectangular, square, circular, oval, triangular, hexagonal, or other polygonal cross sections. Preferably, wallflow articles of this type comprise a plurality of square channels with between 8 and 600 channels per square inch of cross section, a wall thickness of between 0.002 and 0.1 inches, and a water absorption pore volume of between 10% and 70% by weight. Preferred configurations are between 50 and 200 channels per square inch, a wall thickness of between 0.007 and 0.03 inches, and a water absorption pore volume of between 15% and 50%. Particularly useful for the purposes of this invention are the variety of prior art diesel engine exhaust particulate filters which may be catalyzed. U.S. Pat. No. 4,329,162 is herein incorporated by reference with respect to the disclosure of suitable filter elements.

The porous wallflow article used in this invention is catalyzed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic materials and combinations of one or more layers of catalytic materials on the inlet and/or outlet walls of the element.

FIGS. 2 and 3 illustrate a schematic view of a wallflow honeycomb article 30. Alternate channels were plugged at the inlet with inlet plugs 38 and at the outlet with outlet plugs 40 to form opposing checkerboard patterns at the inlet 34 and outlet 36 a gas stream 42 enters through the unplugged channel inlet 44, is stopped by outlet plug 36 and diffuses through channel-walls 33 to the outlet side 46. The gas cannot pass back to the inlet side of walls 33 because of inlet plugs 38. As shown in FIG. 4, the inlet side 48 of wall 33 is coated with a porous catalyst composition.

### EXAMPLES

Several examples of this invention have been reduced to practice in an exhaust stream in the form of full size catalyzed soot filters with a flow-thru oxidation catalyst located in the exhaust stream between the engine and the filter. This system has been tested and evaluated in engine tests under controlled conditions to determine performance. The samples and the test results are described below.

The test program was conducted using a Cummins L-10 (10 liter displacement) engine. This engine, MY'87 was representative of older bus engines, e.g., pre-Euro I (1993) in Europe and gave total particulate emissions of ca. 0.5-0.6 g/bhp-hr over the U.S. HD Transient Test. This engine was used to conduct Balance Point Temperature (BPT) measurements on the test samples a description of the test protocols and method of determining BPT for a sample follows:

1. At the beginning of the test obtain a pressure drop across the trap range for a fully regenerated trap at rated power. This delta P range should be a reliable average of several tests of the same type of substrate measured on a fully warmed up engine at rated power. This delta P value serves as a reference point for all further BPT tests. It is important that each substrate be aged prior to the delta P measurements.

Test Protocol:

2. Engine warm-up for 30 minutes.

3. Measure trap delta P at rated power. If within the clean range, proceed with the trap loading procedure. If delta P is too high, then proceed with the regeneration procedure. This is necessary in order to ensure good test-to-test repeatability.

4. Regeneration procedure:

Regenerate a trap at peak torque, then verify delta P according to Item 3. If necessary, continue with the regeneration process. Duration of regeneration may vary depending on the trap history.

5. If the delta P is within the clean range, then log all of the engine parameters to make sure that the engine still operate properly (no shift in performance).

6. Trap loading procedure:

We are loading trap at 176 ft-lb @ 2100 rpm (approximately 25% of throttle) for 20 minutes. Other conditions can be used as long as exhaust temp. at the trap inlet remains below 600 deg.F.

We log and report delta P at the beginning and at the end of the loading process. This provides relative indication to the amount of soot loaded, which is important for proper interpretation of the test results, as amount of soot may affect BPT. In our case at ETS, typical increase of delta P during the loading session is 0.05 psi.

7. BPT test procedure:

We always run a BPT test in five incremental load steps (approximally 20 deg C. increments), where the step 3 is about at, 1 & 2 are below, and 4 & 5 are above the anticipated BP temperature. This represents our best effort to maintain the same soot load for different traps tested. However, the engine loads may vary due to various BPTs and so does the amount of soot.

This approach requires so called pre-test, which basically involves preliminary defining an anticipated BPT value (usually a short BPT test.

Duration of each load step is 10 minutes. Delta P during the last 6 minutes is used to calculate a trendline slope using linear regression. Each slope value corresponds to a certain exhaust temperature. This gives us 5 data points.

8. The whole procedure starting with the item 3 has to be performed three times. This gives us for a total of 15 data points (slope vs. temperature).

9. Data treatment:

We plot all 15 points together and run a linear regression trendline. The BPT is determined at “Zero” slope.

Description of Flow-Thru Catalyst Compositions:

This catalyst was comprised of 200 g/ft³ Pt on bulk gamma-alumina (2.5 g/in³).

This DOC #2 catalyst was comprised of 5.0 g/ft³ Pt on bulk gamma-alumina (0.83 g/in³), plus bulk zirconia-stabilized ceria (0.83 g/in³) plus bulk iron-exchanged beta zeolite (0.82 g/in³. Total loading of non-Pt washcoat components was 2.5 g/in³.

This DOC #3 catalyst was comprised of 0.5 g/ft³ Pt on bulk gamma-alumina (0.83 g/in³), plus bulk zirconia-stabilized ceria (0.83 g/in³) plus bulk iron-exchanged beta zeolite (0.82 g/in³) Total loading of non-Pt washcoat components was 2.5 g/in³.

The CSF #2 soot filter substrate was catalyzed with 5.0 g/ft³ Pt and 500 g/ft³ CeO₂. Both components were applied to the soot filter substrate via solution impregnation with soluble precursors.

The CSF #3 soot filter was catalyzed with 50.0 g/ft³ Pt and 500 g/ft³ CeO₂. Both components were applied to the soot filter substrate via solution impregnation with soluble precursors.

The CSF #4 soot filter was catalyzed with 65.6 g/ft³ Pt, 500 g/ft³ CeO₂ and 250 g/ft³ ZrO₂. These components were applied to the soot filter substrate via solution impregnation with soluble precursors. The Pt was distributed as 5.0 g/ft³ uniformly over the soot filter substrate and the balance deposited in a separate step to a depth (length) of 4″ inward from on end (face) of the substrate. This provided a Pt-enriched end.

The CSF #5 soot filter was catalyzed with 50.0 g/ft³ Pt, 500 g/ft³ CeO₂ and 250 g/ft³ ZrO₂. The components were applied to the soot filter substrate via solution impregnation with soluble precursors.

The CSF #6 soot filter was catalyzed with 5.0 g/ft³ Pt, 500 g/ft³ CeO₂ and 150 g/ft³ ZrO₂. These components were applied to the soot filter substrate via solution impregnation with soluble precursors. In addition, a washcoat slurry was applied to one end of the soot filter substrate to a depth (length) of ca. 4″ inward from one face of the substrate. This washcoat was comprised of 12.4 wt % Pt on gamma-alumina and was deposited on the one end of the filter substrate to result in a Pt loading of 60.6 g/ft³ equivalent. Thus, the total Pt loading on the CSF was 65.6 g/ft³.

The CSF #7 soot filter was catalyzed with 200 g/ft³ Pt, 500 g/ft³ CeO₂ and 250 g/ft³ ZrO₂. The components were applied to the soot filter substrate via solution impregnation with soluble precursors.

The balance point measurements were run at three speeds on the engine (1300, 1700 & 2100) and incremental load steps were used to attain different exhaust temperatures. In this way a range of conditions under the torque curve of the engine were evaluated. The lower speeds (1300 & 1700 rpm) are probably more representative of bus duty cycle, whereas 2100 rpm represents rated speed for the engine.

Seven of the soot filter Examples used for the tests are described in Table I, below:

TABLE I
Diesel Soot Filter Sample Designations

| Sample | Soot Filter | Pt Loading | |
|---|---|---|---|
| No. | Catalyst Composition | (g/ft³) | Comment |
| 1 | None | 0.0 | Uncatalyzed Soot Filter |
| 2 | Pt/CeO₂ | 5.0 | |
| 3 | Pt/CeO₂ | 50.0 | |
| 4 | Pt/CeO₂ZrO₂ | 65.6 | Pt Enriched End (4″) |
| 5 | Pt/CeO₂ZrO₂ | 50.0 | |
| 6 | Pt/CeO₂Al₂O₃ZrO₂ | 65.6 | Washcoated End (4″) |
| 7 | Pt/CeO₂ZrO₂ | 200.0 | |

Note: Soot Filter Substrate, Corning Cordierite Wall Flow, 11.25″ dia. × 14.0″ long/100 cpsi.

The catalyzed soot filters (CSF) were prepared by solution impregnation of the soot filter substrates. Soluble precursor salts of platinum (platinum amine salt), cerium salt (cerium nitrate) and zirconium salt as zirconium acetate. Where alumina was used, it was a platinum a-alumina slurry in Sample 6. The CSF #2 soot filter substrate was catalyzed with 5.0 g/ft³ Pt and 500 g/ft³ CeO₂. Both components were applied to the soot filter substrate via solution impregnation with soluble precursors. Examples 2 and 3 were catalyzed with Pt and CeO₂ and varied in Pt loading level. Examples 5 and 7 were catalyzed with an improved formulation based on Pt, CeO₂ and ZrQ. The Zrp component was included to achieve better catalyst activity and stability. These two CSF's again varied in Pt, loading level. Example 4 also contained Pt, CeO₂ and ZrQ; however, the Pt on this CSF was distributed as 5.0 g/ft³ fairly uniformly over the soot filter substrate and the balance of the total Pt loading was concentrated in the 4 inch length of one end of the soot filter substrate. All the Pt in Example 4 was applied via solution impregnation. Example 6 was solution impregnated with 5.0 g/ft³ Pt, plus CeO₂ and ZrO₂ in the same way as Example 4, but the balance of the Pt was applied to the 4 inch length of one end as a Pt/Al₂O₃/CeO₂-ZrO₂ slurry washcoat.

Three flow-thru catalysts used in the tests are described in Table II below:

TABLE II
Flow-Thru Catalyst Sample Designations

| Sample | Catalyst | Pt Loading | |
|---|---|---|---|
| No. | Composition | (g/ft³) | Comment |
| Cat #1 | Pt/Al₂O₃ | 200 | NO to NO₂ Catalyst |
| DOC #2 | Pt/Al₂O₃CeO₂ | 5.0 | Diesel Oxidation Catalyst |
| DOC #3 | Pt/Al₂O₃CeO₂ | 0.5 | Diesel Oxidation Catalyst |

Note: Flow-Thru Substrate, Corning 9.5″ dia. × 6.0″ long/300 cpsi.

In Comp #1 the first flow thru catalyst (designated Cat #1) was comprised of a high loading of Pt on gamma-alumina. This catalyst was comprised of 200 g/ft³ Pt on bulk gamma-alumina (2.5 g/in³). This catalyst is a strong oxidation catalyst which has been reported to be effective for soot burn-off and thereby filter regeneration. This catalyst was placed upstream of uncatalyzed SF#1 (Table I) as a control sample. The Comp #1 sample required that it be run on the engine with ultra low sulfur fuel (<50 ppm) because of the inhibition of the catalytic NO to NO₂ oxidation reaction by the SOx in the exhaust and as a result inhibition of filter regeneration. The other flow thru catalysts (designated DOC #2 & #3) were diesel oxidation catalysts which are effective for VOF conversion. This DOC #2 catalyst was comprised of 5.0 g/ft³ Pt on bulk gamma-alumina (0.83 g/in³), plus bulk zirconia-stabilized ceria (0.83 g/in³) plus bulk iron-exchanged beta zeolite (0.82 g/in³). Total loading of non-Pt washcoat components was 2.5 g/in³. This DOC #3 catalyst was comprised of 0.5 g/ft³ Pt on bulk gamma-alumina (0.83 g/in³), plus bulk zirconia-stabilized ceria (0.83 g/in³) plus bulk iron-exchanged beta zeolite (0.82 g/in³. Total loading of non-Pt washcoat components was 2.5 g/in³.

Balance Point Temperature (BPT) tests were conducted on the engine with various CSF and DOC +CSF combinations. Lower BPT indicates a lower temperature at which the rate of soot oxidation is equal to the rate of soot accumulation due to engine exhaust. A summary of the example engine test runs are as follows:

Comp #1: This run evaluated the sample which consisted of the Pt/Al₂O₃ flow-thru (Cat #1) upstream of the uncatalyzed soot filter (SF#1). This sample configuration represented a control case and is consistent with the prior art. This sample was evaluated with the engine running on ultra low sulfur fuel consistent with recommendations of this type of soot filter technology.

Comp #2: This was a repeat run of the sample of Run #1, but with the engine running on normal sulfur fuel.

Comp #3: This run evaluated CSF #5 alone which was catalyzed with Pt and CeO₂ and having a Pt loading level of 5.0 g/ft³. This sample was run using normal sulfur fuel.

Ex #4: This run was a repeat of Comp #3 using CSF #2, but with flow-thru DOC #3 (Pt loading of 0.5 g/ft³) mounted upstream of the soot filter. This sample is an example of this invention and was run using normal sulfur fuel.

Ex #5: This run was a repeat of Ex #4 using CSF #2, but with flow-thru DOC #2 (Pt loading of 5.0 g/ft³) mounted upstream of the soot filter in place of DOC #3. This sample is an example of this invention and was run using normal sulfur fuel.

Comp #6: This run was an evaluation of CSF #3 alone. This filter was catalyzed with Pt/CeO₂ as was CSF #5, but the Pt loading level was 50.0 g/ft³. This sample was run using normal sulfur fuel.

Ex #7: This run was an evaluation of CSF #5 alone. This filter was catalyzed with an improved catalyst formulation consisting of Pt/CeO₂/ZrO₂ and had a Pt loading level of 50 g/ft³. This sample is an example of this invention and it was run using normal sulfur fuel.

Ex #8: This run was also an evaluation of CSF #5, but with flow-thru DOC #2 (Pt loading of 5.0 g/ft³) mounted upstream of the soot filter. This sample is an example of this invention and was run using normal sulfur fuel.

Ex #9: This run was an evaluation of CSF #6 alone. This filter was catalyzed by solution impregnation with Pt/CeO₂/ZrO₂ over the whole filter substrate and the Pt load for this was 5.0 g/ft³. In addition, a 4 inch length of one end of the soot filter substrate was catalyzed with a slurry washcoat comprised of Pt/CeO₂—ZrO₂, Al₂O₃ powders. The Pt loading on this washcoat accounted for the balance of the total Pt loading of 65.6 g/ft³. This sample is an example of this invention. It was run with the 4 inch washcoated and Pt enriched end facing upstream in the exhaust (the inlet) and it was run using normal sulfur fuel.

Ex #10: This run was an evaluation of CSF #4 alone. This filter was catalyzed, like CSF #6, by solution impregnation with a base of Pt/CeO₂/ZrO₂ and having a Pt loading level of 5.0 g/ft³ over the whole filter substrate, but in addition a 4 inch length of one end of the filter substrate was further catalyzed by solution impregnation with additional Pt in an amount to bring the total loading to 65.6 g/ft³. This sample is an example of this invention. For this run it was mounted with the 4 inch Pt-enriched end facing upstream in the exhaust (as the inlet) and it was run using normal sulfur fuel.

Ex #11: This run was a repeat of Ex #10 with CSF #4 having its Pt-enriched end as the inlet, but also with DOC #2 (Pt loading level 5.0 g/ft³) mounted upstream of the CSF in the exhaust. This sample configuration is an example of this invention and it was run using normal sulfur fuel.

Ex #12: This run, like Ex #10, was an evaluation of CSF #4 alone. However, for this run CSF #7 was mounted with its Pt-enriched end in the down stream position (as the outlet) or in reverse flow of that used for Ex #10. This sample configuration is an example of this invention and was run using normal sulfur fuel.

Comp #13: This run was an evaluation of CSF #7 alone. This filter was catalyzed with Pt/CeO₂/ZrO₂ like Ex CSF #5, but in this case the Pt loading level was 200 g/ft³. This sample is an example of this invention and was run using normal; sulfur fuel.

The BPT results for these 13 runs are given in Table III, below. This shows the BPT achieved (deg C) at each of the engine speeds (1300, 1700 & 2100 rpm) used for the individual run. Selected results are also shown in graphical form in FIG. 4, attached.

TABLE III
Soot Filter Regeneration Performance, Balance
Point Temperatures Measurements on 10 Liter,
Pre-Euro I Diesel Engine

| | | Balance Point | | | |
|---|---|---|---|---|---|
| | | Temperature | | | |
| | | (deg C.) | | | |
| Run | Test Case | 1300 | 1700 | 2100 | |
| No. | Description | RPM | RPM | RPM | Comment |
| C1 | Cat #1 + SF | 340 | 373 | 422 | Prior Art, ulS |
| | #1 (Control) | | | | Fuel |
| C2 | Cat #1 + SF | 357 | 417 | 458 | Prior Art, nS |
| | #1 (Control | | | | Fuel |
| C3 | CSF #2 | 418 | 448 | N/a | |
| E4 | DOC #3 + CSF #2 | 359 | 421 | N/a | |
| E5 | DOC #2 + CSF #2 | 356 | 403 | 452 | |
| C6 | CSF #3 | 367 | 427 | 437 | |
| E7 | CSF #5 | 351 | 391 | 433 | |
| E8 | DOC #2 + CSF #5 | 334 | 361 | 428 | |
| E9 | CSF #6 | 351 | 401 | 445 | Pt Washcoat on |
| | | | | | Upstream 4 inches |
| E10 | CSF #4 | 349 | 385 | 437 | Pt Concentration |
| | | | | | on Inlet 4 inches |
| E11 | DOC #2 + CSF #4 | 339 | 378 | 428 | |
| E12 | CSF #4 | 338 | 377 | 409 | Pt Concentration |
| | (Reverse) | | | | on Outlet 4 inches |
| E13 | CSF #7 | 373 | 384 | 413 | |

Note: All runs made using normal sulfur (nS, ca. 350 ppm S) fuel unless noted.

It can be seen that the balance point temperature results for each run (Table III) show a trend toward higher BPT with increasing speed. This behavior can be seen as trend lines in FIG. 4. This is a general feature of all the results and demonstrates the effect of total exhaust mass flow rate and the particulate accumulation rate on the BPT. Each run's catalyst configuration and volume is constant, thus a higher temperature is required for the soot burning rate to keep pace with the higher exhaust rates. Based on these data the performance of the examples for the individual runs can be ranked and the lower the BPT, the better the example.

In Comp #1 the Comparative Example (Comp) exhibited very good BPT performance of 340° C., 373° C. and 422° C. at 1300, 1700 and 2100 RPM, respectively, with the engine running on ultra low sulfur fuel. When in Comp #2 the fuel was changed to the normal sulfur level the BPT performance suffered and increased to 357° C., 417° C. and 458° C., respectively.

In Comp #3 the CSF #5 with low Pt load (5.0 g/ft³) showed rather poor performance with BPT's of 418° C. and 448° C. at 1300 and 1700 RPM, respectively. The BPT for this sample at 2100 RPM was above the maximum exhaust temperature of the engine ca. 460° C. a CSF of this type with this Pt loading level is capable of giving acceptable BPT's and passive regeneration on newer engines having lower particulate emissions levels, but on this older, higher emissions engine the level of performance of Comp #3 would probably not be acceptable.

Improved performance with this type of CSF was achieved with an increase in the Pt loading level (50 g/ft³, CSF #3) as shown in Comp #6 compared to Comp #3 (367° C., 427° C. & 437° C., respectively) These BPT's were only slightly higher than for Comp examples when it was also run on normal sulfur fuel in Comp #2. Thus, Pt loading level on the soot filter substrate is an important variable and increasing can result in improved BPT performance.

In Ex #4 the placement of DOC #3 (0.5 g/ft³ Pt) upstream of CSF #2 resulted in BPT's of 359° C. and 421° C. at 1300 and 1700 RPM, respectively. For this configuration the BPT at 2100 RPM was above the maximum engine exhaust temperature, ca. 460° C. However, the example, of Ex #4 constituted an improvement of 59° C. and 27° C. lower BPT at 1300 and 1700 RPM, respectively, relative to CSF #2 alone. This example of the invention supports the concept that the total particulate matter (TPM) reduction afforded by the DOC enhances the soot burning performance of the CSF. Furthermore, the BPT's achieved for this configuration of the invention in Ex #4 at 1300 and 1700 RPM were comparable with those of Comp #2, which also included Cat #1 and was run on normal sulfur fuel. It should also be noted that the BPT of Comp #2 at 2100 RPM was 458° C., which is very near the maximum exhaust temperature (about 460° C.) of the engine.

Ex #5 used the same configuration as Ex #4, except that the Pt loading level on DOC #2 was 5.0 g/ft³ instead of 0.5 g/ft³. The BPT's achieved with this example of the invention in Ex #5 were 356° C., 403° C. and 452° C., respectively. These results were slightly better that for Ex #4 at 1300 and 1700 RPM where BPT's were achieved. However, the increase in Pt loading on the DOC at these relatively low Pt loading levels had only a moderate effect on lowering the BPT.

Ex's #4 and #5 demonstrate that improved BPT performance can be achieved by placing a DOC in front of a CSF, and this improvement can be achieved with very low precious metal loading. Furthermore, the performance of this configuration of the invention could be expected to be even better on newer, lower emissions diesel engines.

Ex #7, an example of this invention (CSF #5) having an improved catalyst formulation (Pt/CeO₂/ZrO₂) achieved BPT's of 351° C., 391° C. and 433° C., respectively. This represented a significant improvement in BPT performance relative to CSF #3 (Comp #6) which had the same Pt loading level (50 g/ft³) but did not contain ZrO₂. The BPT's were with CSF #5 were lowered by 16° C., 36° C. and 4° C., respectively. CSF #5, run on normal sulfur fuel, was also substantially better than the prior art (control) example, also run on normal sulfur fuel (Comp #2). Furthermore, the BPT performance of CSF #5 was only slightly higher than that of the Comp #1 when run using ultra low sulfur fuel (Run #1).

Ex #13 (CSF #7) which had the same improved catalyst formulation as CSF #5 (Pt/CeO₂/ZrO₂), but with a Pt loading level of 200 g/ft³ was evaluated. For this run BPT's of 373° C., 384° C. and 413° C., respectively, were obtained. Relative to CSF #5 (Ex #7) this performance was poorer at 1300 RPM, slightly better at 1700 RPM and with ca. 20° C. advantage at 2100 RPM. This shows that a large Pt loading level increase (e.g., 50 g/ft³ to 200 g/ft³) does not enhance BPT performance substantially.

Ex #8, also an example of this invention, with DOC #2 (5.0 g/ft³) upstream of CSF #5 BPT's of 334° C., 361° C. and 428° C., respectively, were achieved. This constituted a further improvement relative to CSF #5 alone and the BPT's were lowered by 17° C., 30° C. and 5° C., respectively, relative to Ex #7. This shows the combined effects of the upstream DOC and an improved catalyst on the soot filter. Furthermore, the BPT performance for the configuration in Ex #8 evaluated on normal sulfur fuel constituted an improvement relative to Comp #1.

In Ex #9 the BPT results for CSF #6 were obtained. This soot filter which contained a washcoated length of 4 inches at one end that was run upstream, at the inlet to the soot filter, achieved BPT's of 351° C., 401° C. and 445° C., respectively. This performance was better than that of CSF #2 (Comp #3) and CSF #2 with DOC's mounted upstream (Ex's #4 & 5). However, it was no better and slightly poorer than CSF #5, even with a slightly higher Pt loading level over the upstream 4 inches (65.6 g/ft³ vs 50 g/ft³). This might have been due to the washcoat thickness which covered 4 inches length of one end of the soot filter. This washcoat covered the porous ceramic walls of this area of the soot filter substrate which likely resulted in impeded exhaust flow. This in turn effectively reduced the filtration area (volume) of the soot filter resulting in higher BPT's.

Ex #10 the BPT results for CSF #4 alone, were obtained. This soot filter, which had an enriched Pt loading on 4 inches of length of one end was run with the Pt-enriched end upstream, at the inlet. The BPT's for this configuration were 349° C., 385° C. and 437° C., respectively. This performance was comparable with that of CSF #5 in Ex #7. This shows that the Pt loading on the CSF can be placed at the inlet or spread more uniformly throughout the volume of the soot filter substrate and obtain the same results. In an additional run of CSF #4, ultra low sulfur fuel was used in place of normal sulfur fuel and the BPT results were comparable, thus showing that the CSF's of this invention are not sensitive to the sulfur level in the fuel, unlike Comp's #1 & #2.

Ex #11, DOC #2 (5.0 g/ft³ Pt) was mounted upstream of CSF #4. This configuration, an example of this invention, gave BPT's of 339° C., 378° C. and 428° C., respectively. This was an improvement relative to CSF #4 alone and BPT's were 10° C., 7° C. and 9° C. lower, respectively. Furthermore, the performance of this configuration in Ex #11 using normal sulfur fuel was comparable with Comp #1, using ultra low sulfur fuel.

Ex #12, CSF #4 alone was run in reverse flow orientation with respect to the exhaust compared with the way it was evaluated in Ex #10. In this configuration, an example of this invention, the end of the soot filter with Pt-enriched 4″ length was mounted down stream, at the outlet. The BPT's obtained in Ex #12 were 338° C., 377° C. and 409° C., respectively. This constituted an improvement in performance compared to the case when CSF #4 was run with its Pt-enriched end mounted upstream, at the inlet, (Ex #10). This was a surprise and demonstrated that the placement of the Pt on the soot filter substrate could be important to performance and that distributing the Pt on the outlet end of the filter substrate provided an advantage. Furthermore, the performance of CSF #4 mounted in this orientation and using normal sulfur fuel was comparable with Comp #1.

1. An apparatus comprising:
a diesel engine having an exhaust outlet;
a catalyzed filter in communication with the exhaust outlet, the catalyzed filter comprising a first catalyst, the first catalyst comprising:
a first platinum group metal; and
a first cerium component; and
a second catalyst in communication with the first catalyst, the second catalyst comprising:
a second cerium component.

2. An apparatus comprising:
a diesel engine having an exhaust outlet;
a catalyzed filter in communication with the exhaust outlet, the catalyzed filter comprising a first catalyst, the first catalyst comprising:
a first platinum group metal;
a first cerium component; and
a first zirconium component.

3. The apparatus as recited in claim 2 further comprising:
a second catalyst in-communication with the first catalyst, the second catalyst comprising:
a second cerium component.

4. The apparatus as recited in claims 1 or 3 wherein the second catalyst is located between the engine outlet and the first catalyst.

5. The apparatus as recited in claim 4 wherein the second catalyst is supported on a separate substrate than the catalyzed filter.

6. The apparatus as recited in claim 4 wherein the second catalyst is located at the catalyzed filter.

7. The apparatus as recited in claim 6 wherein the catalyzed filter has an axial length extending from an upstream filter end to a downstream filter end, and the second catalyst is located for at least part of the axial length from the upstream end.

8. The apparatus as recited in claim 7 wherein the second catalyst for from about 0.25 to about 8 inches from the upstream end.

9. The apparatus as recited in claim 8 wherein the second catalyst for from about 0.5 to about 5 inches from the upstream end.

10. The apparatus as recited in claims 1 or 3 wherein the second catalyst is located downstream of the first catalyst.

11. The apparatus as recited in claims 1 or 3 wherein the second catalyst is located between the engine outlet and the catalyzed filter.

12. The apparatus as recited in claims 1 or 3 wherein the second catalyst is located downstream of the first catalyst.

13. The apparatus as recited in claim 12 wherein the second catalyst is supported on a separate substrate than the catalyzed filter.

14. The apparatus as recited in claim 12 wherein the second catalyst is located at the catalyzed filter.

15. The apparatus as recited in claim 14 wherein the catalyzed filter has an axial length extending from an upstream filter end to a downstream filter end, and the second catalyst is located for at least part of the axial length from the upstream end.

16. The apparatus as recited in claim 15 wherein the second catalyst for from about 0.25 to about 8 inches from the upstream end.

17. The apparatus as recited in claim 16 wherein the second catalyst for from about 0.5 to about 5 inches from the upstream end.

18. The apparatus as recited in claims 1 or 3 wherein the second catalyst is located downstream of the catalyzed filter.

19. The apparatus as recited in claim 1 wherein the first catalyst further comprises a first zirconium component.

20. The apparatus as recited in claims 1 or 3 wherein the second catalyst composition comprises a second metal oxide selected from silica, alumina, titania and zirconia.

21. The apparatus as recited in claim 20 wherein the second catalyst-composition comprises a catalytic material comprising at least one second metal oxide selected from silica, alumina, titania, zirconia, silica-alumina and ceria-zirconia.

22. The apparatus as recited in claim 21 wherein the second cerium component is bulk ceria having a BET surface area of at least about 10 m²/g and the second metal oxide is a bulk metal oxide having a BET surface area of at least about 10 m²/g.

23. The apparatus as recited in claim 22 wherein the second catalyst composition comprises ceria and a metal oxide in a weight ratio of from 5:95 to 95:5.

24. The apparatus as recited in claim 22 wherein the second catalyst comprises at least one second platinum group metal component.

25. The apparatus as recited in claim 24 wherein the second platinum group component is selected from platinum, palladium, and rhodium components.

26. The apparatus as recited in claim 25 wherein the second platinum group components are present in an amount of from 0.1 to 200 g/ft³ based on the weight of the metal.

27. The apparatus as recited in claim 26 wherein the second platinum group component is a platinum component in an amount from 0.1 to 15 g/ft³ based on the weight of the metal.

28. The apparatus as recited in claim 27 wherein the second platinum component is in an amount from 0.1 to 5 g/ft³ based on the weight of the metal.

29. The apparatus as recited in claim 26 wherein the second platinum group component is a second platinum component in an amount from 0.1 to 0.5 g/ft³ based on the weight of the metal.

30. The apparatus as recited in claims 1 or 3 wherein the first catalyst composition comprises a first metal oxide selected from silica, alumina, titania and zirconia.

31. The apparatus as recited in claim 30 wherein the first catalyst composition comprises a catalytic material comprising at least one first metal oxide selected from silica, alumina, titania, zirconia, silica-alumina and ceria-zirconia.

32. The apparatus as recited in claim 31 wherein the first cerium component is bulk ceria having a BET surface area of at least about 10 m²/g and the first metal oxide is a bulk metal oxide having a BET surface area of at least about 10 m²/g.

33. The apparatus as recited in claim 32 wherein the first catalyst composition comprise ceria and metal oxide in a weight ratio of from 5:95 to 95:5.

34. The apparatus as recited in claim 30 wherein the second platinum group component is selected from platinum, palladium, and rhodium components.

35. The apparatus as recited in claim 34 wherein the second platinum group components are present in an amount of from 0.1 to 200 g/ft³ based on the weight of the metal.

36. The apparatus as recited in claims 1 or 3 wherein the catalyzed soot filter comprises a wall flow honeycomb substrate.

37. The apparatus as recited in claims 1 or 3 wherein the second catalyst is supported on a flow through honeycomb substrate.

38. An apparatus comprising:
a catalyzed filter comprising a first catalyst, the first catalyst comprising:
a first platinum group metal; and
a first cerium component; and
a second catalyst in communication with the first catalyst, the second catalyst comprising:
a second cerium component.

39. The apparatus as recited in claim 38 wherein the catalyzed soot filter comprises a wall flow honeycomb substrate.

40. The apparatus as recited in claim 39 wherein the second catalyst is supported on a flow through honeycomb substrate.
